(19) United States
(12) Patent Application Publication
(10) Pub. No.: US 2008/0178123 A1
(43) Pub. Date: Jul. 24, 2008

(54) METHOD OF CONTROLLING AN ELECTRONIC DEVICE IN A CALENDAR VIEWING APPLICATION

(75) Inventor: Darrell R. MAY, Waterloo (CA)

Correspondence Address: PERRY + CURRIER INC.;(FOR RIM), 1300 YONGE STREET, SUITE 500, TORONTO, ON, M4T-1X3, omitted

(73) Assignee: RESEARCH IN MOTION LIMITED, Walerloo (CA)

(21) Appl. No.: 11/624,285

(22) Filed: Jan. 18, 2007

(51) Int. Cl. G06F 3/048

(52) U.S. Cl. 715/856

(57) ABSTRACT

A method of controlling a portable electronic device includes retrieving from at least one database of the electronic device, calendar events that meet a set of constraints, and providing the calendar events that meet the set of constraints in a month-view calendar graphical user interface including a week number displayed based on a location of a cursor in the month-view calendar graphical user interface.

### FIELD OF TECHNOLOGY

The present disclosure relates to calendar applications and to controlling an electronic device during scrolling in a month-view calendar graphical user interface.

### BACKGROUND

Portable electronic devices including, for example, smart telephones and wireless PDAs are becoming increasingly common and typically integrate functions of personal information management such as calendaring and data communications such as email, World Wide Web browsing and telecommunications in a single device. Such devices run on a wide variety of networks from data-only networks such as Mobitex and DataTAC to complex voice and data networks such as GSM/GPRS, CDMA, EDGE, UMTS AND CDMA2000 networks.

Calendar applications permit the user of the portable electronic device to schedule and review calendar events such as appointments and meetings on a visual display such as a liquid crystal display (LCD) screen of a certain size. Calendar events can typically be viewed in any of a variety of graphical user interface layouts including, for example, a day view, a week view, a month view or an agenda view. Portable electronic devices such as handheld devices are generally small and have limited screen space for display of pertinent information, however. Thus, when displaying calendar events in a month-view calendar graphical user interface, an entire month is represented on screen of limited size. Week information that a user may wish to see may be difficult to display due to screen size restrictions or may not fit onto such a screen.

It is therefore desirable to provide the user of the portable electronic device with pertinent week information without unduly limiting the amount of screen space left for the remaining month-view calendar graphical user interface.

### BRIEF DESCRIPTION OF THE DRAWINGS

The embodiments described herein will be better understood with reference to the following Figures, in which:

FIG. 1 is a front view of an exemplary portable electronic device;

FIG. 2 is a block diagram of certain components, including internal components within the portable electronic device of FIG. 1;

FIG. 3 is an exemplary menu screen displayed on a display of the portable electronic device of FIG. 1;

FIG. 4 is an exemplary screen showing a month-view calendar graphical user interface including a week number;

FIG. 5 is a flowchart showing the steps in a method for controlling a portable electronic device, according to an embodiment;

FIGS. 6 and 7 are exemplary screens showing month views in a calendar graphical user interface including respective week numbers; and

FIG. 8 is a front view of another exemplary portable electronic device.

### DETAILED DESCRIPTION OF THE EMBODIMENTS

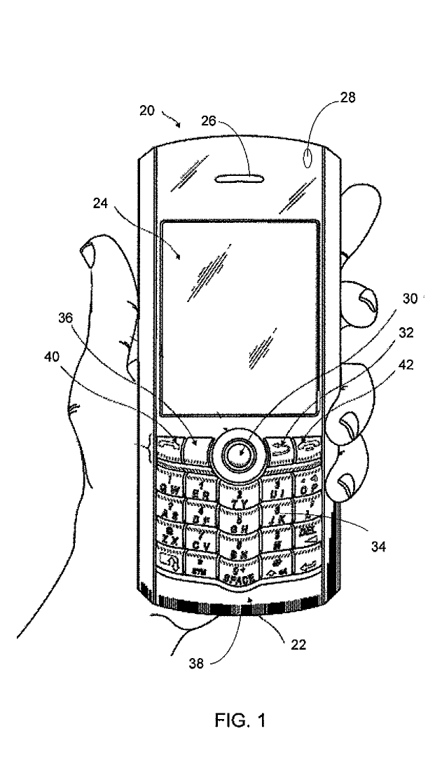

Referring to FIG. 1, a portable electronic device in accordance with an embodiment is indicated generally by the numeral 20. In the present embodiment, the portable electronic device 20 is based on the computing environment and functionality of a hand-held wireless communication device. It will be understood, however, that the electronic device is not limited to a hand-held wireless communication device. Other electronic devices are possible, such as cellular telephones, smart telephones, and laptop computers. Referring again to the present embodiment, the portable electronic device 20 includes a housing 22 that frames an LCD display 24, a speaker 26, an LED indicator 28, a trackball 30, an exit key 32, a key pad 34, a menu key 36, a microphone 38, an initiate call key 40 and an end call key 42. The trackball 30 can be inwardly depressed as a means to provide additional user-input for user-selection of items and options displayed on the LCD display 24, for example. The housing 22 is made from a suitable material as will occur to those skilled in the art, and can be stored, for example, in a holster (not shown) that includes an attachment for attaching to a user's belt.

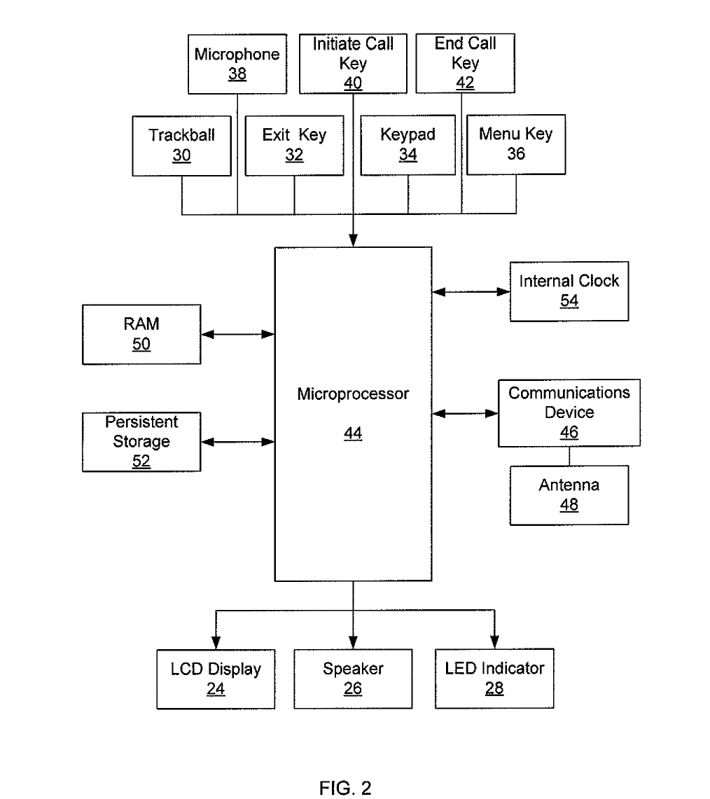

Referring now to FIG. 2, a block diagram of certain components, including certain internal components within the portable electronic device 20, is shown. The portable electronic device 20 is based on a microcomputer that includes a microprocessor 44 (also referred to herein as a processor) connected to a random access memory unit (RAM) 50 and a persistent storage device 52 that is responsible for various non-volatile storage functions of the portable electronic device 20. Operating system software executable by the microprocessor 44 is stored in the persistent storage device 52, which in the present embodiment is flash memory. It will be appreciated, however, that the operating system software can be stored in other types of memory such as read-only memory (ROM). The microprocessor 44 receives input from various input devices including the trackball 30, the exit key 32, the keypad 34, the menu key 36, the microphone 38, the initiate call key 40, and the end call key 42, and outputs to various output devices including the LCD display 24, the speaker 26 and the LED indicator 28. The microprocessor 44 is also connected to an internal clock 54.

In the present embodiment, the portable electronic device 20 is a two-way RF communication device having voice and data communication capabilities. The portable electronic device 20 also includes Internet communication capabilities. Two-way RF communication is facilitated by a communications device 46 that is used to connect to and operate with a data-only network such as Mobitex or DataTAC, or a complex voice and data network such as a GSM/GPRS, CDMA, EDGE, UMTS or CDMA2000 network, via the antenna 48.

Although not shown, a battery provides power to all active elements of the portable electronic device 20.

The persistent storage device 52 also stores a plurality of applications executable by the microprocessor 44 that enable the portable electronic device 20 to perform certain operations including the communication operations referred to above. Other applications software is provided including, for example, an email application, a Web browser application, an address book application, a calendar application, a profiles application, and others.

It will be appreciated that the calendar application is used for providing a graphical user interface (GUI) for the user to create calendar events and for storage of the calendar events in a database at the persistent storage device 52, when executed by the processor 44. The calendar application is also used for displaying calendar events such as appointments, lectures, exams, movies, meetings, performances, dinners, ceremonies, etc. as described below. Each calendared event includes a variety of information including a date and time of the event. The term date/time is used throughout the present description. It will be appreciated that the term date/time refers to date and time.

The LCD display 24 of the portable electronic device is configurable to display visual representations of the calendar events stored in a database on the persistent storage device 52. The calendar events are displayed in a user-selected one of various calendar views including a day view, a week view, a month view and an agenda view. The month view provides a view of a month organized into weeks, each week appearing on a different line of the month view (also referred to herein as the month-view calendar graphical user interface). The calendar events are displayed by identifiers in the appropriate day in which the calendar event is scheduled for user identification of dates that include scheduled calendar events.

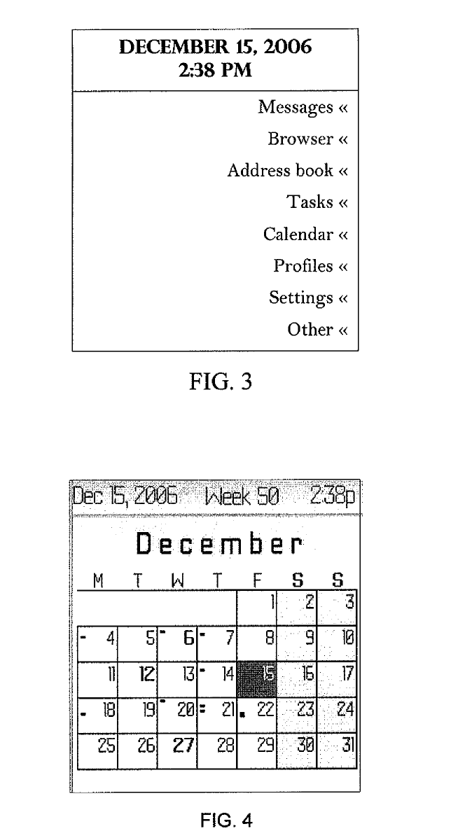

Referring to FIG. 3, there is shown an exemplary menu screen that is displayed on the LCD display 24 of the portable electronic device 20. The exemplary menu screen includes a display clock that is updated according to the internal clock 44, and a list of applications including an email messaging application, a Web browser, an Address book, a Tasks application, and a Calendar application. Each of the displayed applications in the list is selectable by, for example, scrolling to the desired application using the trackball 30 and depressing the trackball 30.

Selection of the Calendar application causes execution of the calendar application by the microprocessor 36 and a user-selected one or default one of the calendar views is displayed on the LCD display 24. In the month view, the current month according to the internal clock, is displayed as a default view. Thus, if the current month is December, as shown in FIG. 3, the default view is the month of December of the current year. The calendar events scheduled for different days are shown by respective indicators listed within calendar box representations of the respective days, as shown in FIG. 4. The user can scroll side to side, upwardly and downwardly in the month view, thereby scrolling ahead or backward in time using the trackball 30.

User selection of any particular day of the month by, for example, scrolling to the desired day and depressing the trackball 30, results in the display of a day view for the respective day. Any calendar event within that day is shown in the day view, permitting user-selection of the calendar event to view details or user-selection of any free time for the addition of a further calendar event.

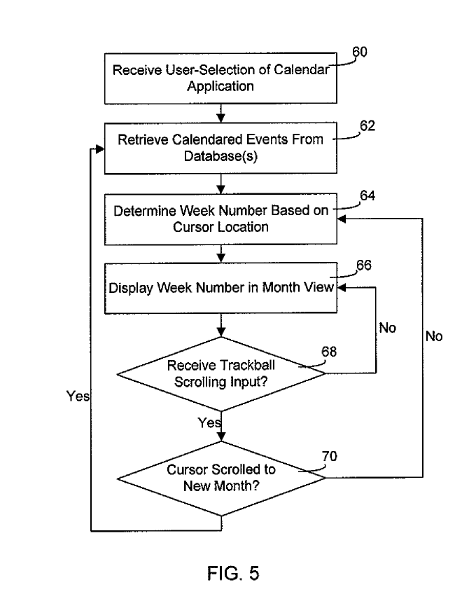

Reference is now made to FIG. 5 to describe an embodiment of the present application. It will be appreciated that each of the steps of FIG. 5 is carried out by routines or subroutines of the calendar software executed by the microprocessor 44. Coding of software for carrying out such steps is well within the scope of a person of ordinary skill in the art. Upon selection of the calendar application from the exemplary menu screen shown in FIG. 3, the microprocessor 44 receives the user-selection (step 60) and executes a routine of the calendar application. For the purpose of the present example, the calendar application default view is the month view. It will be appreciated, however that the default view can be any view and can be changed by user selection of a new default view. Also, the view can be changed from any other view to the month view by user selection of a month view option in a calendar options menu. The details of how the default view is selected or how a calendar view is changed are not important in the present discussion.

As indicated above, the month view displays the current month according to the internal clock and the calendar events scheduled for different days are shown by respective indicators listed within calendar box representations of the respective days. To display the month view, all calendar events that meet specified constraints are retrieved from the database in which the calendar events are stored at the persistent storage device 52 (step 62). The constraints include, for example, all calendar events that have a start time/date or end time/date that falls within the month to be displayed. In the present example, the calendar application is selected and the default display is the month view for the current month. Thus, all calendar events that have either or both of a start time/date and an end time/date that fall within the current month according to the internal clock 54, are retrieved from the database (step 62).

After retrieving the calendar events, a week number is determined based on a cursor location (step 64). In the present exemplary embodiment, the default view is the month view for the current month according to the internal clock 54 and the cursor defaults to the current day within the month view, according to the internal clock. The week number is therefore first determined based on the cursor location, which is located at the current day according to the internal clock 54.

Next, the month view is displayed including the week number determined at step 64 (step 66). The month view also includes the calendar events retrieved at step 62. The calendar events are represented by indicators within the days represented in the month view. In the example of FIG. 4, the week number is listed at the top of the screen as Week 50 in a single horizontal line of the display. Also, December 4, 6, 7, 14, 18, 20, 21 and 22 include calendar events represented by indicators. December 21 includes two calendar events represented by two indicators. It will be appreciated from the foregoing discussion that in the exemplary screen shot of FIG. 4, the cursor defaults to Dec. 15, 2006 as Dec. 15, 2006 is the current day according to the internal clock 54. As shown in FIG. 4, the cursor is a movable highlight symbol that highlights any given day. In the example of FIG. 4, the day representing Dec. 15, 2006 is highlighted by the cursor.

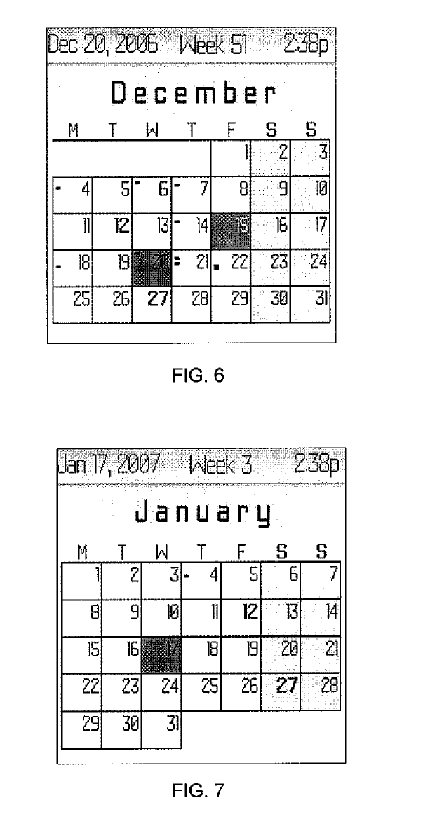

Movement by rolling of the trackball 30 causes movement of the cursor in the month view and is determined by the microprocessor 44 (step 68). In the absence of rolling of the trackball 30, the method proceeds to step 66. Thus, the microprocessor 44 continues to display the month view including the week number shown on initial display of the month view. When rolling of the trackball 30 is detected (step 68), the method proceeds to step 70 where it is determined if the movement of the trackball 30 results in the user scrolling to a new month, either by scrolling to the previous month or the next month. If the user scrolls the trackball, thereby moving the cursor within the same month, the method returns to step 64 where the week number is determined. Thus, the week number is again determined based on the cursor location and the month view displayed at step 66 includes the week number for the day to which the cursor has been moved. FIG. 6 is an exemplary screen showing the cursor located at December 20, rather than December 15, as shown in FIG. 4. The week number has changed to Week 51 in the present example, as the cursor is now located on a day that falls within week 51 of the year. It will be appreciated that the current date is highlighted to for ease of reference by the user. The current date is highlighted with a different highlight attribute than that of the cursor located at December 20 in the exemplary screen of FIG. 6. For example, the cursor can be highlighted is a colour or shade that is different than that of the current date.

If the user rolls the trackball 30, thereby scrolling the cursor to a different month, the method returns to step 62 where calendar events that meet a set of constraints are retrieved from the calendar database. If, for example, the user scrolls the cursor to the next month (January, 2007), all calendar events that have one or both of a start time/date and an end time/date that falls within the month of January (the new month to be displayed), are retrieved from the calendar database. The week number is again determined based on the cursor location (step 64) and the month view is displayed including the week number determined at step 64 and indicators representing the calendar events retrieved at step 62 (step 66). FIG. 7 is an exemplary screen showing the cursor located at Jan. 17, 2007. Thus, the cursor is moved by scrolling downwardly using the trackball 30 from the position shown in FIG. 6 to the position shown in FIG. 7. In the present case, the month to be displayed changes and this change is determined at step 70. Thus, calendar events with at least one of a start time/date and an end time/date that fall within the month of January, 2007 are retrieved. The week number in which the cursor is located is determined to be week 3 of 2007 (step 64). Thus, the week number is displayed in the month view as Week 3, as shown in FIG. 7. Thus, the week number is dynamically determined when the user moves the cursor around by scrolling in the month view of the calendar application.

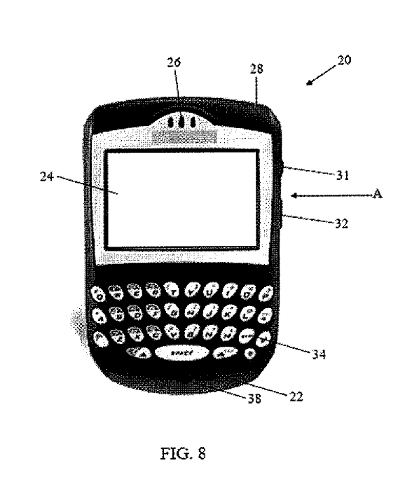

It will be appreciated that the portable electronic device of FIG. 1 is shown for exemplary purposes only. Other portable electronic devices such as that shown in FIG. 8 are possible. Referring to FIG. 8, another exemplary portable electronic device 20 is shown. The portable electronic device 20 includes a housing 22 that frames an LCD display 24. In the present example, however, the portable electronic device 20 includes a trackwheel 31, rather than a trackball. The trackwheel 31 can be depressed as a means to provide additional user-input. The microprocessor 44 receives input from the trackwheel 31 which is used for user selection of features from a list or a table on the LCD display 24 of the portable electronic device 22. Selection is carried out by rolling the trackwheel to roll a cursor (which can be a highlighted region), for example, to the desired selection and pressing inwardly on the trackwheel, in the direction of arrow “A”. The portable electronic device 20 shown in FIG. 8 includes many other features, including, for example, a key pad 34 and other features similar to those described above with reference to FIG. 1. It will also be appreciated that reference is made to a trackball in the above description for exemplary purposes only, and a trackwheel 31 such as that shown in FIG. 8 can be used.

According to one aspect there is provided a method of controlling a portable electronic device. The method includes retrieving from at least one database of the electronic device, calendar events that meet a set of constraints, and providing the calendar events that meet the set of constraints in a month-view calendar graphical user interface including a week number displayed based on a location of a cursor in the month-view calendar graphical user interface.

According to another aspect, there is provided an electronic device. The electronic device includes a memory for storage of a plurality of calendar events in at least one database, a display device for displaying the calendar events in a month-view calendar graphical user interface, a user input device for user interaction in the month-view calendar graphical user interface, and a processor connected to the memory, the display device and the user input device. The processor is for retrieving from the at least one database of the electronic device, calendar events that meet a set of constraints, and providing the calendar events that meet the set of constraints in the month-view calendar graphical user interface including a week number displayed based on a location of a cursor in the month-view calendar graphical user interface.

According to another aspect, there is provided a computer program product for displaying a plurality of calendar events in a month-view calendar graphical user interface of the electronic device. The computer program product includes a computer-readable medium having computer-readable code embodied therein for retrieving from at least one database of the electronic device, calendar events that meet a set of constraints, and providing the calendar events that meet the set of constraints in a month-view calendar graphical user interface including a week number displayed based on a location of a cursor in the month-view calendar graphical user interface.

Week numbers are traditionally not displayed in the month view of a calendar graphical user interface due to limited availability of space. The present application provides for the display of a week number based on the location of a cursor within the month-view calendar graphical user interface. As the user scrolls through the month view, the week number is determined and displayed. Thus, only a single week number is displayed at any time making it easy for the user to determine in a quick, “at a glance” view, the week number of the date scrolled to. Further, only a single week number is displayed rather than all week numbers of weeks shown in the month-view, thereby limiting the space required for week number information.

While embodiments described herein are directed to particular implementations of the method for controlling an electronic device, it will be understood that modifications and variations to these embodiments are within the scope and sphere of the present application. For example, it will be appreciated that the screens shown are provided for exemplary purposes only and the display attributes of any of the exemplary screens can vary. Further, although the default view of the calendar application is described above as being the month view, it will be appreciated that the present application is not limited to a default month view and any default view can be used. Also, although the calendar events that are retrieved at step 62 of FIG. 5 are described as being retrieved from one database, the calendar events can, in fact, be retrieved from a number of databases. Further still, multiple calendar databases that correspond to different calendar accounts synchronized or transferred to the portable electronic device can be maintained. With multiple calendar databases, the calendar events can be retrieved from any or all of the databases.

Many other modifications and variations may occur to those skilled in the art. All such modifications and variations are believed to be within the sphere and scope of the present application.

1. A method of controlling a portable electronic device, the method comprising:
retrieving from at least one database of said electronic device, calendar events that meet a set of constraints; and
providing said calendar events that meet said set of constraints in a month-view calendar graphical user interface including a week number displayed based on a location of a cursor in said month-view calendar graphical user interface.

2. The method according to claim 1, wherein said set of constraints comprise a one-month time period represented in said month-view calendar graphical user interface.

3. The method according to claim 1, wherein said providing comprises determining a week number of a week in which the cursor is located in said month-view calendar graphical user interface and displaying said week number based on said determination.

4. The method according to claim 3, wherein said determining said week number comprises dynamically determining said week number during user input resulting in scrolling of said cursor in said month-view calendar graphical user interface.

5. The method according to claim 4, comprising repeating said retrieving and said providing when a user input results in the representation of a different month in said month-view calendar graphical user interface.

6. An electronic device comprising:
a memory for storage of a plurality of calendar events in at least one database;
a display device for displaying said calendar events in a month-view calendar graphical user interface;
a user input device for user interaction in said month-view calendar graphical user interface; and
a processor connected to the memory, the display device and the user input device, for retrieving from said at least one database of said electronic device, calendar events that meet a set of constraints, and providing said calendar events that meet said set of constraints in said month-view calendar graphical user interface including a week number displayed based on a location of a cursor in said month-view calendar graphical user interface.

7. A computer program product for displaying a plurality of calendar events in a month-view graphical user interface of an electronic device, said computer program product comprising a computer-readable medium having computer-readable code embodied therein for:
retrieving from at least one database of said electronic device, calendar events that meet a set of constraints; and
providing said calendar events that meet said set of constraints in a month-view calendar graphical user interface including a week number displayed based on a location of a cursor in said month-view calendar graphical user interface.
